(19) United States
(12) Patent Application Publication
(10) Pub. No.: US 2009/0235815 A1
(43) Pub. Date: Sep. 24, 2009

(54) PISTON WITH BUILT-IN SEAL

(75) Inventors: Tomoaki Nishimura, Fukushima-shi (JP); Junichi Ishiyama, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/440,536

(22) PCT Filed: Aug. 23, 2007
(86) PCT No.: PCT/JP2007/066332

§ 371 Date: Mar. 9, 2009

(30) Foreign Application Priority Data
Oct. 27, 2006 (JP) 2006-292308

(51) Int. Cl. F16J 1/00

(52) U.S. Cl. 92/240

(57) ABSTRACT

A piston with a built-in seal comprises a piston body (121) formed of a metal press-formed part and axially movably disposed in a clutch cylinder (110) and seal lips (122, 123) formed integrally with the piston body (121). A through tubular guide projection (124) is formed on the piston body (121). A return spring (150) for biasing the piston body (121) toward the pressurizing chamber (A) side is held on the guide projection (124). Since the press-formed through tubular guide projection (124) is higher in projecting height than the bottomed tubular one, the length over which the return spring (150) is held is longer. A pressurizing chamber (A) is prevented from being opened by the guide projection (124).

### CROSS-REFERENCE TO RELATED APPLICATIONS

This is a national stage of the International Application No. PCT/JP2007/066332 filed on Aug. 23, 2007 and published in Japanese language.

### BACKGROUND OF THE INVENTION

1. Field of the Invention

The present invention relates to a piston with built-in seal used for a hydraulic operation clutch in an automatic transmission for a vehicle.

2. Description of the Conventional Art

In a hydraulic operation clutch in an automatic transmission for a motor vehicle, a clutch piston axially moving in a clutch cylinder by hydraulic pressure makes a drive plate at the drive shaft side and a driven plate at the driven shaft side in a multiple disk clutch to be contacted with pressure. As for the clutch piston, a piston with built-in seal (also called as bonded piston seal) is known. Such the piston with built-in seal is formed by integrating of seal lips to an outer peripheral part and an inner peripheral part of a piston body through vulcanizing and bonding.

FIG. 4 is a half sectional view of a conceptual configuration of a hydraulic operation clutch having a conventional piston with built-in seal, which is shown by a section along a plane passing through an axis O of the drive shaft. FIG. 5 is an expanded sectional view of a part of FIG. 4. In the hydraulic operation clutch illustrated in FIG. 4, a reference numeral 1 is an annular clutch cylinder rotated with a drive shaft which is not illustrated. A numeral 2 is a piston with built-in seal, which is disposed to be axially movable in the clutch cylinder 1. A numeral 3 is a spring holder disposed axially facing the piston with built-in seal 2 and fixed at an inner peripheral tube part 1a of the clutch cylinder 1 through a retaining ring 31. A numeral 4 is a multiple disc clutch in which a plurality of drive plates 41 and a plurality of driven plates 42 are axially alternately disposed. The drive plates 41 are locked to the clutch cylinder 1 in a circumference direction in the state of being axially movable and the driven plates 42 are locked to a clutch hub 43 provided at the not-illustrated driven shaft side in a circumference direction in the state of being axially movable. An outer peripheral skirt part 2a of the piston with built-in seal 2 axially faces the drive plate 41 of the multiple disc clutch 4, and a return spring 5 is inserted between the piston with built-in seal 2 and the spring holder 3 in the state of being properly compressed.

A plurality of the return springs 5 are disposed at a predetermined interval in the circumference direction around the axis O. One end 5a of each of return springs 5 is fitted to and locked by a circular guide projection 23 formed by embossing on the piston with built-in seal 2, and another end 5b is held by a projection edge 3a formed along the outer periphery of the spring holder 3.

The piston with built-in seal 2 integrally has seal lips 21 and 22 made of a rubber like elastic material on the inner and outer peripheries thereof, and the seal lips 21 and 22 tightly and slidably contact to the inner peripheral tube part 1a and the outer peripheral tube part lb of the clutch cylinder 1 respectively. Further, the inner peripheral tube part 1a of the clutch cylinder 1 has an oil passage 11 for introducing hydraulic pressure by oil (ATF) into a pressurizing chamber 6 defined between the clutch cylinder 1 and the piston with a built-in seal 2.

That is, when hydraulic pressure is applied to the pressurizing chamber 6 through the oil passage 11, the piston with built-in seal 2 is axially displaced in the clutch cylinder 1 in the direction for compressing the return spring 5 and presses the drive plate 41 toward the driven plate 42 in the multiple disc clutch 4. Therefore, the hydraulic operation clutch becomes in a connection state for transmitting drive power from the drive shaft to the driven shaft.

Then, when the hydraulic pressure in the pressurizing chamber 6 is released, the piston with built-in seal 2 is axially displaced in the clutch cylinder 1 in the direction to decrease the capacity of the pressurizing chamber 6 by pressing force of the compressed return spring 5 and cancels the pressure contact of the drive plate 41 to the driven plate 42 in the multiple disc clutch 4. Therefore, the transmission of the drive power from the drive shaft to the driven shaft is disconnected (for example, refer to Unexamined Japanese Patent Publication Laid-Open No. 9-189336).

However, according to the aforementioned conventional technique, the guide projection 23 for locking the one end 5a of each return spring 5 is embossed to have a bottomed shape at the time of press forming of the piston with built-in seal 2. Thus, as illustrated in FIG. 5, an embossing height h cannot be made so high, while a diameter φ of the guide projection 23 is hardly decreased because of the strength of a press type punch. Therefore, the return spring 5 is loosened, inclined, or relatively rotated due to centrifugal force generated by rotation, etc. Thus, there are pointed-out problems that the return force of the piston with built-in seal 2 by the return springs 5 is not stable at a time of releasing of hydraulic pressure in the pressurizing chamber 6, and that the one end 5a of the return spring 5 is displaced as illustrated with broken lines in FIG. 5 due to deflection of the return spring 5 so that the return spring is easily removed from the guide projection 23.

### SUMMARY OF THE INVENTION

### Problems to Be Solved by the Invention

The present invention is to solve the aforementioned problems, and an object of the present invention is to provide a piston with built-in seal capable of effectively preventing the occurrences of looseness, inclination, and relative rotation of return springs.

### Means for Solving the Problem

In order to attain the aforementioned object, a piston with built-in seal according to a first aspect of the present invention includes a piton body made of a metal press-formed part and disposed to be axially movable in a clutch cylinder, and seal lips formed integrally on the piston body, wherein through tubular guide projections are formed on the piston body at positions at the outer side from a pressurizing chamber defined between the clutch cylinder and the piston body by the seal lips, and return springs for pressing the piston body toward the pressurizing chamber side are held on the guide projections.

According to the aforementioned configuration, since the guide projections of the piston body have a through tubular shape, the projection height of the press-formed guide projections, that is, the length of the parts for holding the return springs, can be enlarged than that of the guide projections press-formed to have a bottomed tubular shape.

A piston with built-in seal according to a second aspect of the present invention has the guide projections recited in the first aspect at the outer side from the pressurizing chamber defined between the clutch cylinder and the piston body by the seal lips. Accordingly, the through tubular guide projections prevent opening of the pressurizing chamber.

A piston with built-in seal according to a third aspect of the present invention has the guide projections described in the first aspect at a pressure receiving part of the piston body which faces to the pressurizing chamber defined between the clutch cylinder and the piston body by the seal lips, and inner peripheries of the guide projections are tightly plugged with plugging parts made of a rubber like elastic material. Accordingly, the through tubular guide projections prevent opening of the pressurizing chamber.

### Effectiveness of the Invention

According to the piston with built-in seal according to the first to third aspects, since the guide projections formed on the piston body have a through tubular shape, the length of the parts for holding the return springs held on the guide projections can be made longer. As a result, looseness, inclination, and relative rotation of the return springs due to centrifugal force, etc. generated by rotation can be effectively prevented, and the return force toward the pressurizing chamber side by the pressing force of the return spring can be stabilized.

### BRIEF EXPLANATION OF DRAWINGS

FIG. 1 is a half sectional view of a first embodiment of a piston with built-in seal according to the present invention, which is shown by a section along a plane passing through an axis O of the drive shaft together with a part of a hydraulic operation clutch,

FIG. 2 is a expanded sectional view of a part of FIG. 1,

FIG. 3 is a half sectional view of a second embodiment of a piston with built-in seal according to the present invention, which is shown by a section along a plane passing through an axis O of the drive shaft together with a part of a hydraulic operation clutch,

FIG. 4 is a half sectional view of a conceptual configuration of a hydraulic operation clutch having a conventional piston with built-in seal, which is shown by a section along a plane passing through an axis O of the drive shaft, and

FIG. 5 is an expanded sectional view of a part of FIG. 4.

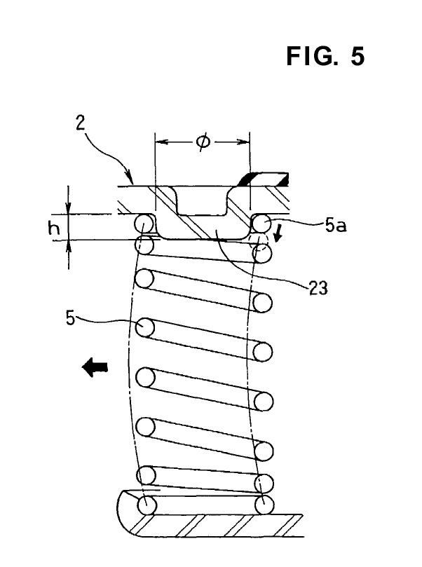

### DETAILED DESCRIPTION OF PREFERRED EMBODIMENTS

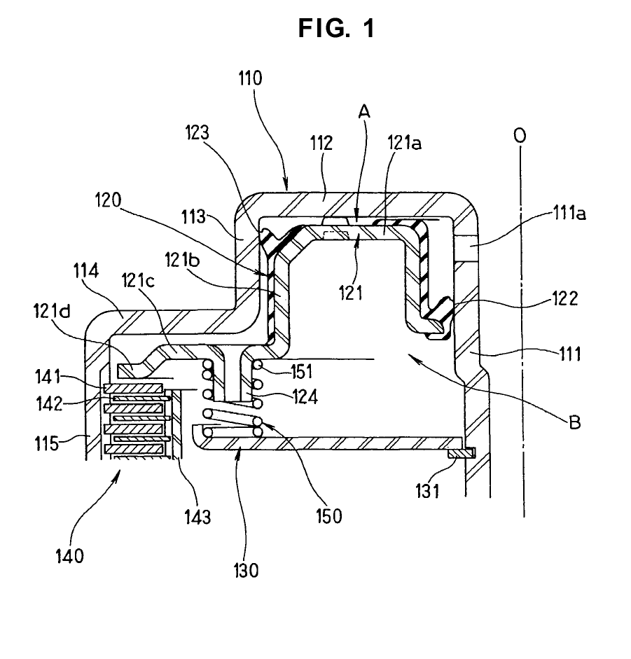

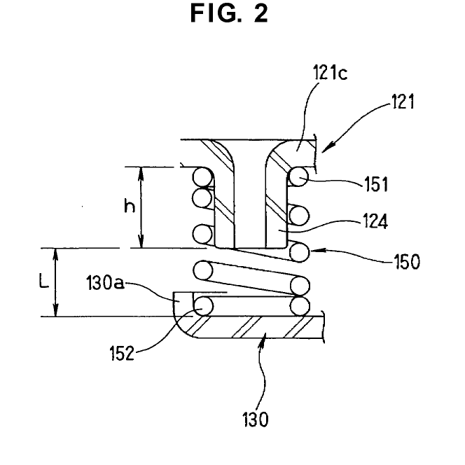

Preferred embodiments of a piston with built-in seal according to the present invention will be described below with reference to the drawings. FIG. 1 is a half sectional view of a first embodiment of a piston with built-in seal according to the present invention, which is shown by a section along a plane passing through an axis O of the drive shaft with a part of a hydraulic operation clutch. FIG. 2 is an expanded sectional view of a part of FIG. 1.

In a hydraulic actuator for an automatic transmission illustrated in FIG. 1, a reference numeral 110 is a clutch cylinder rotated around an axis O with a not-illustrated drive shaft. The clutch cylinder 110 is formed in an annular shape. The clutch cylinder 110 includes an inner peripheral tube part 111, an inner peripheral disk part 112 extending from an axial one end of the inner peripheral tube part, an intermediate tube part 113 formed backwardly from an outer peripheral end part of the inner peripheral disc part 112, and coaxially with the inner peripheral tube part 111, an outer peripheral disk part 114 expanding to the outer peripheral side from an end part of the intermediate tube part 113, and an outer peripheral tube part 115 extending coaxially with the inner peripheral tube part 111, from an outer peripheral end part of the outer peripheral disc part 114.

A reference numeral 120 is a piston with built-in seal disposed so as to be axially movable in the clutch cylinder 110. A reference numeral 130 is a spring holder disposed axially facing the piston with built-in seal 120 and fixed at the inner peripheral tube part 111 of the clutch cylinder 110 through a retaining ring 131. A reference numeral 140 is a multiple disc clutch in which a plurality of drive plates 141 and a plurality of driven plates 142 are axially alternately disposed. The drive plates 141 are locked to the outer peripheral tube part 115 of the clutch cylinder 110 in a circumference direction in the state of being axially movable, and the driven plates 142 are locked to a clutch hub 143 provided at the not-illustrated driven shaft side in a circumference direction in the state of being axially movable. A reference numeral 150 is a return spring inserted between the piston with built-in seal 120 and the spring holder 130 in the state of being properly compressed.

The piston with built-in seal 120 includes an annular piston body 121 around an axis O, and seal lips 122 and 123 formed integrally with the piston body 121.

The piston body 121 in the piston with built-in seal 120 is made of a metal by press-forming. The piston body 121 includes a pressure receiving part 121a at the inner peripheral side which axially faces the inner peripheral disc part 112 of the clutch cylinder 110, a flange part 121c expanding to have a disk shape from the outer peripheral side of the pressure receiving part 121a through an outer tube part 121b and axially facing the outer peripheral disk part 114 of the clutch cylinder 110, and a clutch pressing part 121d formed at an outer peripheral end part of the flange part 121c and axially facing the drive plate 141 of the multiple disc clutch 140 closely.

The seal lips 122 and 123 in the piston with built-in seal 120 are formed integrally on an inner peripheral part and an outer peripheral part of the pressure receiving part 121a in the piston body 121 with a rubber like elastic material. Among these seal lips, the seal lip 122 on the inner peripheral side is slidably brought in close contact with an inner peripheral face of the inner peripheral tube part 111 of the clutch cylinder 110, and the seal lip 123 on the outer peripheral side is slidably brought in close contact with an inner peripheral face of the intermediate tube part 113 of the clutch cylinder 110. Further, a pressurizing chamber A is defined between the clutch cylinder 110 and the pressure receiving part 121a of the piston body 121 by the seal lips 122 and 123, and an oil passage 111a for introducing hydraulic pressure by oil (ATF) into the pressurizing chamber A is provided in the inner peripheral tube part 111 of the clutch cylinder 110.

The flange part 121c of the piston body 121 in the piston with built-in seal 120 has guide projections 124 which project in the reverse direction to the facing direction to the outer peripheral disk part 114 of the clutch cylinder 110, that is, toward the spring holder 130 side. The guide projections 124 are formed to project in a through tubular shape by deep drawing at the flange part 121c at the time of press-forming of the piston body 121, and a plurality of the guide projections 124 are provided at a predetermined interval in the circumference direction around the axis O.

The return spring 150 is a metallic coil spring. A plurality of the return springs 150 are disposed at a predetermined interval in the circumference direction around the axis O, and are provided between the flange part 121c of the piston body 121 and the spring holder 130 in the state of being properly compressed. As illustrated in FIG. 2, one end 151 of each of the return springs 150 is fitted on the guide projection 124 to be thereby held in the state of contacting to the flange part 121c. Another end 152 is contacted with the spring holder 130, and displacement toward the outer peripheral side of the other end 152 is regulated by a projection edge 130a formed along the outer periphery thereof.

Further, a facing distance L between the guide projections 124 and the spring holder 130 at the time when the piston with built-in seal 120 is placed at an upper side stroke end position for making the capacity of the pressurizing chamber A to be the minimum, is set to be properly larger than a stroke length of the piston with built-in seal 120. That is, even when the piston with built-in seal 120 is moved to a lower side stroke end position where the clutch pressing part 121d presses the multiple disc clutch 140, the guide projections 124 do not contact to the spring holder 130.

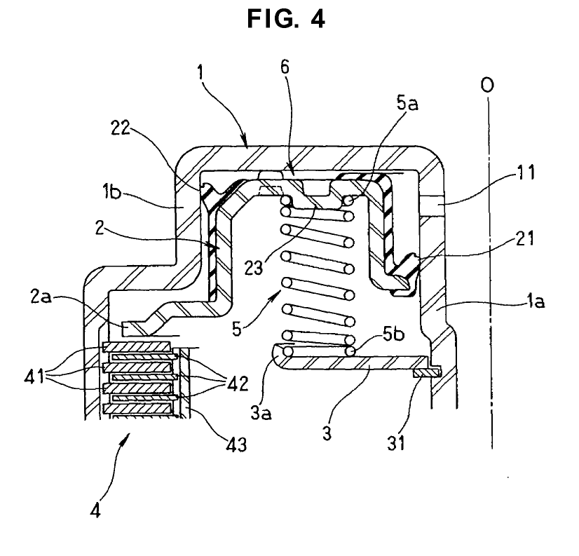

According to the aforementioned configuration, when operational hydraulic pressure is applied to the pressurizing chamber A through the oil passage 111a or the hydraulic pressure is released, the piston with built-in seal 120 is displaced axially in the clutch cylinder 110 so as to make the multiple disc clutch 140 to carry out a connecting operation or a disconnecting operation, like the aforementioned configuration in FIG. 4.

That is, when the pressurizing chamber A is pressurized by supplying of oil, the piston with built-in seal 120 is displaced downward in FIG. 1 while compressing the return springs 150, and the clutch pressing part 121d of the piston with built-in seal 120 frictionally engages the drive plates 141 and the driven plates 142 of the multiple disc clutch 140. Consequently, the multiple disc clutch 140 becomes in the connection state, and a drive torque from a not-illustrated drive shaft side is transmitted to a not-illustrated driven shaft through the clutch cylinder 110, the drive plate 141 and the driven plate 142 of the multiple disc clutch 140, and the clutch hub 143.

Further, when the hydraulic pressure in the pressurizing chamber A is released in the connection state, the piston with built-in seal 120 is displaced upward in FIG. 1 so as to decrease the volume of the pressurizing chamber A by returning force of the compressed return springs 150, and then the pressing to the multiple disc clutch 140 is canceled. Thus, the frictional engaging of the drive plates 141 and the driven plates 142 of the multiple disc clutch 140 is canceled, and transmission of the drive torque from the drive shaft to the driven shaft is disconnected.

In those operations, the guide projections 124 in the piston with built-in seal 120 are formed to project in a through tubular shape by deep drawing. Thus, a projection height h illustrated in FIG. 2, that is, a length h of the parts for holding the return springs 150 fitted on the guide projections 124 to be thereby held, can be made sufficiently larger than that of the conventional one formed in a bottomed tubular shape by embossing. Therefore, looseness, inclination, and relative rotation of the return springs 150 due to centrifugal force etc. generated by rotation can be effectively suppressed, and thus returning force of the piston with built-in seal 120 toward the pressurizing chamber A side by pressing force of the return springs 150 can be stabilized.

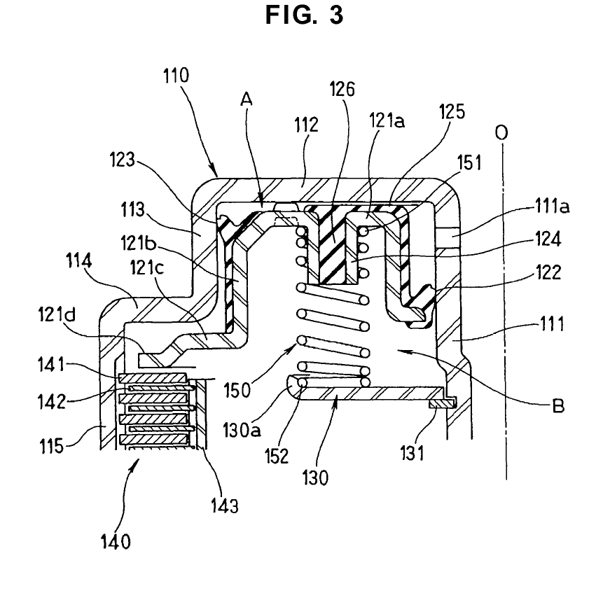

Then, FIG. 3 is a half sectional view of a second embodiment of a piston with built-in seal according to the present invention, which is shown by a section along a plane passing through an axis O of the drive shaft together with a part of a hydraulic operation clutch. In the aforementioned first embodiment illustrated in FIG. 1, in order to prevent that the piston with built-in seal 120 becomes inoperable because the pressurizing chamber A communicates with a space B at the spring holder 130 side by the through tubular guide projections 124, the guide projections 124 are formed at the flange part 121c in the piston body 121, that is, are formed at an outer position from the seal lip 123 for defining the pressurizing chamber A. In contrast, in the second embodiment, the guide projections 124 are formed at the pressure receiving part 121a of the piston body 121, and inner peripheries thereof are filled with a rubber like elastic material to be thereby tightly plugged.

That is, as illustrated in FIG. 3, the flange part 121c of the piston body 121 in the piston with built-in seal 120 does not have guide projections, and the guide projections 124 are formed at the pressure receiving part 121a of the piston body 121 to project toward the reverse direction to the facing direction to the inner peripheral disk part 112 of the clutch cylinder 110, that is, toward the spring holder 130 side. The guide projections 124 are formed to project in a through tubular shape by deep drawing at the pressure receiving part 121a at the time of press-forming of the piston body 121, and a plurality of the guide projections 124 are provided at a predetermined interval in the circumference direction around the axis O.

An elastic layer 125 is formed so as to cover a face at the pressurizing chamber A side of the pressure receiving part 121 a of the piston body 121 and extends from a base of the seal lip 122 (or the seal lip 123). A plugging parts 126 extending from the elastic layer 125 plug the inner peripheries of the through tubular guide projections 124. That is, when the seal lips 122 and 123 are formed integrally on the piston body 121 with a rubber like elastic material, the plugging parts 126 are formed by a part of the rubber material being filled in the inner peripheries of the guide projections 124.

A plurality of the return springs 150 are disposed at a predetermined interval in the circumference direction around the axis O, and provided between the pressure receiving part 121a of the piston body 121 and the spring holder 130 in the state of being properly pre-compressed. Further, one end 151 of each of the return springs 150 is fitted on the guide projection 124 to be thereby held in the state of contacting to the pressure receiving part 121a. Another end 152 is contacted with the spring holder 130 and displacement toward the outer peripheral side of the other end 152 is regulated by a projection edge 130a formed along an outer periphery of the spring holder 130.

In addition, other parts of the second embodiment are basically configured like FIG. 1.

That is, like the first embodiment, since the guide projections 124 of the piston with built-in seal 120 are formed to project in a through tubular shape by deep drawing and the return springs 150 are fitted on such the guide projections 124, a length of the parts for holding the return springs 150 can be made sufficiently large. Therefore, looseness, inclination and relative rotation of the return springs 150 due to centrifugal force etc. generated by rotation can be effectively suppressed, and thus returning force of the piston with built-in seal toward the pressurizing chamber A side by pressing force of the return springs 150 can be stabilized.

Further, the inner peripheries of the through tubular guide projections 124 formed at the pressure receiving part 121a of the piston body 121 are tightly plugged with the plugging parts 126 made of a rubber like elastic material. Thus, it can be prevented that the piston with built-in seal 120 becomes inoperable because the pressurizing chamber A communicates with the space B on the spring holder 130 side.

1. A piston with built-in seal comprising:
a piston body made of a metal press-formed part and disposed to be axially movable in a clutch cylinder; and
seal lips formed integrally on the piston body,
wherein through tubular guide projections are formed on the piston body, and
wherein return springs for pressing the piston body toward a pressurizing chamber side are held on the guide projections, the pressurizing chambers being defined between the clutch cylinder and the piston body by the seal lips.

2. The piston with built-in seal as claimed in claim 1,
wherein the guide projections are placed at the outer side in a diameter direction from the pressurizing chambers defined between the clutch cylinder and piston body by the seal lips.

3. The piston with built-in seal as claimed in claim 1,
wherein the guide projections are placed at a pressure receiving part of the piston body which faces the pressurizing chambers defined between the clutch cylinder and the piston body by the seal lips, and the inner peripheries of the guide projections are tightly plugged with plugging parts made of a rubber like elastic material.
